(19) United States
(12) Patent Application Publication
(10) Pub. No.: US 2017/0360033 A1
(43) Pub. Date: Dec. 21, 2017

(54) STABILIZATION OF ISOTHIAZOLONES IN AQUEOUS COMPOSITIONS

(71) Applicants: Rohm and Haas Company, Philadelphia, PA (US); Dow Global Technologies LLC, Midland, MI (US)

(72) Inventors: Bolatito Ajayi, Lansdale, PA (US); David M. Laganella, Swedesboro, NJ (US)

(21) Appl. No.: 15/531,020

(22) PCT Filed: Dec. 8, 2015
(86) PCT No.: PCT/US2015/064370

§ 371 Date: May 26, 2017

Related U.S. Application Data
(60) Provisional application No. 62/093,674, filed on Dec. 18, 2014.

(51) Int. Cl. A01N 25/22; A01N 43/80; A01N 25/30

(52) U.S. Cl. CPC A01N 25/22; A01N 25/30; A01N 43/80

(57) ABSTRACT

An aqueous composition comprising: (a) 4,5-dichloro-2-octyl-4-isothiazolin-3-one; (b) a tertiary amine comprising three C₂-C₆ hydroxyalkyl groups, wherein at least one of said hydroxyalkyl groups has a secondary hydroxyl group; (c) an oil selected from the group consisting of mineral oil, neutral oil, castor oil, and combinations thereof; (d) a paraffin wax; and (e) a nonionic surfactant having from 20 to 50 polymerized ethylene oxide units.

This invention relates to aqueous compositions useful in wood treatment containing isothiazolones and tertiary amine compounds.

A fluid composition containing a 3-isothiazolone and alkanolamines is disclosed in U.S. Pub. No. 2008/0280792. This reference discloses that the 3-isothiazolone needs to be stabilized by addition of iodine-containing stabilizers or mercaptobenzothiazole. However, use of such stabilizers in fluids, including wood treatment fluids, is undesirable for economic and environmental reasons.

The problem addressed by this invention is to provide an improved aqueous composition useful for wood treatment containing 3-isothiazolones and alkanolamines

### STATEMENT OF THE INVENTION

The present invention is directed to an aqueous composition comprising: (a) 4,5-dichloro-2-octyl-4-isothiazolin-3-one; (b) a tertiary amine comprising three C₂-C₆ hydroxyalkyl groups, wherein at least one of said hydroxyalkyl groups has a secondary hydroxyl group; (c) an oil selected from the group consisting of mineral oil, neutral oil, castor oil, and combinations thereof; (d) a paraffin wax; and (e) a nonionic surfactant having from 20 to 50 polymerized ethylene oxide units.

### DETAILED DESCRIPTION OF THE INVENTION

“MIT” is 2-methyl-4-isothiazolin-3-one, also referred to by the name 2-methyl-3-isothiazolone. “CMIT” is 5-chloro-2-methyl-4-isothiazolin-3-one, also referred to by the name 5-chloro-2-methyl-3-isothiazolone. Preferably, the weight ratio of CMIT to MIT is at least 2:1, preferably at least 2.5:1. Preferably, the weight ratio of CMIT to MIT is no greater than 4:1, preferably no greater than 3.5:1. In one preferred embodiment of the invention, the CMIT:MIT ratio is about 3:1. “OIT” is 2-octyl-4-isothiazolin-3-one. “DCOIT” is 4,5-dichloro-2-octyl-4-isothiazolin-3-one.

Concentrations listed in ppm are parts per million by weight (weight/weight). Unless otherwise specified, temperatures are in degrees centigrade (° C.), references to percentages are percentages by weight (wt %) and amounts and ratios are on an active ingredient basis, unless otherwise specified. When experiments are described as being carried out at “room temperature” or when a temperature is not specified this indicates a temperature from 20-25° C.

The aqueous composition of this invention is useful in wood treatment. The composition may be contacted with wood by conventional means know in the art, including, e.g., pressure treatment, brushing or spraying, dipping and soaking. Preferably, the concentration of DCOIT in the composition is from 100 to 1000 ppm; preferably at least 200 ppm, preferably at least 300 ppm, preferably at least 400 ppm; preferably no more than 900 ppm, preferably no more than 800 ppm. Preferably, the composition further comprises OIT in a concentration from 50 to 600 ppm; preferably at least 100 ppm, preferably at least 150 ppm; preferably no more than 500 ppm, preferably no more than 400 ppm. Preferably, the composition further comprises CMIT and MIT in a total concentration from 25 to 500 ppm; preferably at least 50 ppm, preferably at least 100 ppm; preferably no more than 400 ppm, preferably no more than 300 ppm.

The hydroxyalkyl groups in the tertiary amine may be the same or different. Preferably, two of the hydroxyalkyl groups have a secondary hydroxyl group. Preferably, the tertiary amine has three C₂-C₅ hydroxyalkyl groups, preferably three C₂-C₄ hydroxyalkyl groups, preferably three hydroxyalkyl groups each of which is a C₂ or C₄ hydroxyalkyl group. Preferably, C₂ hydroxyalkyl groups are 2-hydroxyethyl groups. Preferably, C₃ hydroxyalkyl groups are 2-hydroxy-1-propyl groups. Preferably, C₄ hydroxyalkyl groups are 2-hydroxy-1-butyl groups. Preferably, the tertiary amine has at least one hydroxybutyl group. Especially preferred amines include N,N-bis(2-hydroxybutyl)-2-aminoethanol, 1-[bis(2-hydroxyethyl)amino]-2-butanol and triisopropanol amine (TIPA, CAS no. 122-20-3); preferably N,N-bis(2-hydroxybutyl)-2-aminoethanol or 1-[bis(2-hydroxyethyl)amino]-2-butanol. More than one amine may be present.

Preferably, the aqueous composition contains from 0.5 to 10 wt % of tertiary amine(s) comprising three C₂-C₆ hydroxyalkyl groups, wherein at least one of said hydroxyalkyl groups has a secondary hydroxyl group; preferably at least 1 wt %, preferably at least 1.5 wt %, preferably at least 2 wt %, preferably at least 2.5 wt %, preferably at least 3 wt %; preferably no more than 9 wt %, preferably no more than 8 wt %, preferably no more than 7 wt %, preferably no more than 6 wt %. The aqueous composition preferably contains at least 80 wt % water, preferably at least 85 wt %, preferably at least 90 wt %, preferably at least 92 wt %; preferably no more than 99 wt %, preferably no more 98 wt %, preferably no more than 97 wt %, preferably no more than 96 wt %.

Preferably, the oil is present in a concentration from 0.2 to 2 wt %; preferably at least 0.3 wt %, preferably at least 0.4 wt %; preferably no more than 1.5 wt %, preferably no more than 1.2 wt %, preferably no more than 1 wt %. Preferably, the oil is castor oil.

Preferably, the paraffin wax is present in a concentration from 0.2 to 2 wt %; preferably at least 0.3 wt %, preferably at least 0.4 wt %, preferably at least 0.5 wt %; preferably no more than 1.5 wt %, preferably no more than 1.3 wt %, preferably no more than 1.1 wt %. Preferably, the paraffin wax has a melting point of <75° C. Preferably, the nonionic surfactant is present in a concentration from 0.01 wt % to 1 wt %; preferably at least 0.1 wt %, preferably at least 0.15 wt %, preferably at least 0.2 wt %; preferably no more than 0.8 wt %, preferably no more than 0.7 wt %, preferably no more than 0.6 wt %, preferably no more than 0.5 wt %. Preferably, the nonionic surfactant has at least 25 polymerized ethylene oxide units, preferably at least 30, preferably at least 35; preferably no more than 45. Preferably the polymerized ethylene oxide units in the nonionic surfactant are bonded to a substituent having from 20 to 70 carbon atoms; preferably at least 25, preferably at least 30, preferably at least 35, preferably at least 40, preferably at least 45, preferably at least 50; preferably no more than 65, preferably no more than 60. The substituent may have more than one polymerized ethylene oxide chain, in which case the total number of ethylene oxide units in all of the chains corresponds to the limits above. Preferably, the substituent is castor oil (i.e., the surfactant is a castor oil ethoxylate).

Preferably, the aqueous composition further comprises an anionic surfactant. Preferably, the anionic surfactant is a sulfonate or sulfate. Preferably, the anionic surfactant has from 10 to 25 carbon atoms, preferably from 12 to 22, preferably from 14 to 20. Preferred anionic surfactants include, e.g., alkylbenzene sulfonates.

Preferably, the aqueous composition is substantially free of bromic acid, iodic acid, periodic acid or their salts and mercaptobenzothiazole, i.e., the composition contains less than 0.05% total of these substances, preferably less than 0.01%, preferably less than 0.005%, preferably less than 0.001%.

### EXAMPLES

Hydroxyl Content—Hydroxyl content was measured by derivatization of the amine alkoxylate with an excess of phthalic anhydride reagent with imidazole catalyst in pyridine solvent at 100° C. for 30 min using a procedure based on ASTM D 4274. After formation of the phthalate half ester, the unreacted phthalic anhydride was hydrolyzed and titrated with 1 N sodium hydroxide reagent using a Mettler DL-55 titrator. The half ester was quantified by the difference between the sample titration and a blank titration of the same amount of phthalic anhydride reagent completely hydrolyzed with water. The difference is expressed as hydroxyl number (mg KOH/g sample) or % OH. For the amine butoxylates (functionality=3) analyzed in this study, the molecular weight is calculated by the following formula: (3×1700)/% OH.

H-1 NMR—The amine butoxylate sample in chloroform-d was prepared in a 5 mm NMR tube. The data were collected by a PROTON experiment on a BRUKER 300 MHz NMR.

Synthesis of Monoethanolamine (MEA) and Diethanolamine (DEA) Butoxylates

All of the alkoxylation reactions were performed in a jacketed, baffled 9L stainless steel autoclave reactor equipped with a magnetically driven impeller, pressure transducer, jacket return line thermocouple, and redundant reactor thermocouples. Temperature control was achieved with a mixture of steam and cooling water to the reactor jacket introduced via control valves operated by the MOD-V digital control system. Butylene oxide (BO) was charged into a designated feed tank situated on a scale. BO was metered from the feed tank bottom outlet to the reactor through an automated flow control valve within the operating temperature (±5° C. of set point) and pressure (16-85 psia) constraints. These runs targeted the butoxylation of MEA with 2 BO equivalents and DEA with 1 BO equivalent.

Monoethanolamine and Diethanolamine were obtained from Aldrich. Dow butylene oxide was obtained from the Freeport Market Development Plant.

Preparation of MEA Dibutoxylate (N,N-bis(2-hydroxybutyl)-2-aminoethanol)

This run targeted the butoxylation (2 BO) of Monoethanolamine (MEA) without addition of catalyst (amine autocatalytic) using a 110° C. feed temperature and a 110° C. digest temperature. MEA (901.7 g) was charged to a 9L reactor. The reactor was pressurized with nitrogen and vented (7 times) to remove atmospheric oxygen. Subsequently, the reactor was pressurized with nitrogen to 16-20 psia at ambient temperature. The reactor contents were heated with agitation at 110° C., then BO (2180 g total) was metered into the reactor over 4 hr at 110° C. resulting in an operating pressure of 30 psia. After the BO feed was complete, the reactor contents were agitated at 110° C. for an additional 10 hr (overnight) to consume unreacted oxide (digest). The reactor was cooled to approximately 100° C., then nitrogen sparged for 1 hr to remove any unreacted butylene oxide. Subsequently, the reactor was cooled to 60° C. and drained affording 3056.1 g of product. A sample of the reaction product analyzed by hydroxyl titration (25.228%0H corresponding to 202 MW or MEA+2.0BO). Proton NMR spectroscopy provided an estimated BO:MEA molar ratio of 2.1.

Preparation of DEA Monobutoxylate (1-[bis(2-hydroxyethyl)amino]-2-butanol)

This run targeted the butoxylation (1 BO) of Diethanolamine (DEA) without addition of catalyst (amine autocatalytic) using a 110° C. feed temperature and a 110° C. digest temperature. DEA (1960.2 g) was charged to a 9 L reactor. The reactor was pressurized with nitrogen then vented (7 times) to remove atmospheric oxygen. Subsequently, the reactor was pressurized with nitrogen to 16-20 psia at ambient temperature. The reactor contents were heated with agitation at 110° C., then BO (1395 g total) was metered into the reactor over 2½ hr at 110° C. resulting in an operating pressure of 25-30 psia. After the BO feed was complete, the reactor contents were agitated at 110° C. for an additional 17 hr (overnight) to consume unreacted oxide (digest). The reactor was cooled to approximately 100° C., then nitrogen sparged for 1 hr to remove any unreacted butylene oxide. Subsequently, the reactor was cooled to 60° C. and drained affording 3161.4 g of product. A sample of the reaction product analyzed by hydroxyl titration (28.494% OH corresponding to 179 MW or DEA+1.0BO). Proton NMR spectroscopy provided an estimated BO:DEA molar ratio of 1.0.

The wood treatment solutions containing amines comprised 4% amine, 94% water, 0.7% castor oil, 0.8% paraffin wax, 0.3% castor oil ethoxylate (40 EO), amounts of isothiazolones indicated in the table below, as well as other minor ingredients (anionic surfactant, biocides, etc.). The wood treatment solutions not containing amines comprised 98% water and were otherwise the same as those containing amines.

The samples were analyzed for DCOIT, CMIT, MIT, and OIT on Days 0, 5, 8, and 13 after storage at room temperature (21 C+/−1 C) and at 50 C. The HPLC analysis conditions are below:

Column: Poroshell 120 SB-C18, 4.6 mm×50 mm×2.7 um

Flow Rate: 1.6 mL/min

Column temperature: 40 C

Injection volume: 5 uL

UV detection at 280 nm

Mobile Phase: 20/80 Water/Methanol, gradient below

| Time | % Methanol |
|---|---|
| 0 | 80 |
| 1.6 min | 80 |
| 1.7 min | 100 |
| 2.3 min | 100 |
| 2.4 min | 80 |
| 5 min Stop | 80 |

Working standards of all 4 actives were prepared from provided analytical standards of 45.8% OIT, 14.17% CMIT/MIT, 24.8% DCOIT.

Results for the wood treatment solution with different amines and under different conditions are presented in the table below

| | Theor. | 0 | 5 | 8 | 13 |
|---|---|---|---|---|---|
| Sample ID - CMIT Data | | | | | |
| No Amine, Stored at RT | 178 | 181 | 196 | 187 | 185 |
| 4% MEA, Stored at RT | 151 | 28.2 | 7.22 | ND | ND |
| 4% Amine#1, Stored at RT | 152 | 154 | 57.7 | 33.0 | ND |
| 4% Amine#2, Stored at RT | 312 | 228 | 45.3 | 22.3 | ND |
| No Amine, Stored at 50 C. | 178 | N/A | 191 | 183 | 182 |
| 4% MEA, Stored at 50 C. | 151 | N/A | 11.7 | ND | ND |
| 4% Amine#1, Stored at | 152 | N/A | ND | ND | ND |
| 50 C. | | | | | |
| 4% Amine#2, Stored at | 156 | N/A | ND | ND | ND |
| 50 C. | | | | | |
| Sample ID - MIT Data | | | | | |
| No Amine, Stored at RT | 58.0 | 84.9 | 87.4 | 83.4 | 82.8 |
| 4% MEA, Stored at RT | 49.3 | 135 | 59.5 | 51.2 | 47.1 |
| 4% Amine#1, Stored at RT | 49.7 | 78.0 | 90.1 | 76.8 | 77.6 |
| 4% Amine#2, Stored at RT | 51.0 | 78.9 | 86.2 | 80.5 | 84.6 |
| No Amine, Stored at 50 C. | 58.0 | N/A | 90.4 | 84.0 | 83.5 |
| 4% MEA, Stored at 50 C. | 49.3 | N/A | 9.44 | 5.61 | 7.20 |
| 4% Amine#1, Stored at | 99.4 | N/A | 80.9 | 75.2 | 66.9 |
| 50 C. | | | | | |
| 4% Amine#2, Stored at | 102 | N/A | 85.3 | 77.0 | 68.4 |
| 50 C. | | | | | |
| Sample ID - OIT Data | | | | | |
| No Amine, Stored at RT | 258 | 253 | 263 | 262 | 256 |
| 4% MEA, Stored at RT | 245 | 253 | 225 | 225 | 216 |
| 4% Amine#1, Stored at RT | 244 | 254 | 268 | 255 | 257 |
| 4% Amine#2, Stored at RT | 243 | 250 | 248 | 242 | 243 |
| No Amine, Stored at 50 C. | 258 | N/A | 251 | 242 | 232 |
| 4% MEA, Stored at 50 C. | 245 | N/A | 10.3 | 7.70 | 8.03 |
| 4% Amine#1, Stored at | 244 | N/A | 251 | 251 | 248 |
| 50 C. | | | | | |
| 4% Amine#2, Stored at | 243 | N/A | 246 | 239 | 237 |
| 50 C. | | | | | |
| Sample ID - DCOIT Data | | | | | |
| No Amine, Stored at RT | 603 | 616 | 627 | 627 | 622 |
| 4% MEA, Stored at RT | 600 | 583 | ND | ND | ND |
| 4% Amine#1, Stored at RT | 606 | 617 | 588 | 567 | 557 |
| 4% Amine#2, Stored at RT | 600 | 614 | 577 | 550 | 532 |
| No Amine, Stored at 50 C. | 603 | N/A | 615 | 613 | 611 |
| 4% MEA, Stored at 50 C. | 600 | N/A | ND | ND | ND |
| 4% Amine#1, Stored at | 606 | N/A | 428 | 359 | 279 |
| 50 C. | | | | | |
| 4% Amine#2, Stored at | 600 | N/A | 368 | 289 | 202 |
| 50 C. | | | | | |

Amine #1 is 1-[bis(2-hydroxyethyl)amino]-2-butanol
Amine #2 is N,N-bis(2-hydroxybutyl)-2-aminoethanol
MEA is 2-aminoethanol

The pH of the MEA samples was higher than those containing other amines (11.9 vs. 10.3), so the stability study was repeated with the MEA samples adjusted with HCl to pH 10.3. The results are presented below. For some time periods, the CMIT and MIT concentrations were not measured and these points are designated by “NM.”

| | Theor. | 0 | 1 | 4 | 7 |
|---|---|---|---|---|---|
| Sample ID - CMIT Data | | | | | |
| No Amine, Stored at RT | 256 | 255 | 255 | 251 | NM |
| 4% MEA, Stored at RT | 128 | 121 | 158 | 107 | NM |
| 4% Amine#1, Stored at RT | 256 | 258 | 262 | 262 | NM |
| 4% Amine#2, Stored at RT | 256 | 242 | 249 | 252 | NM |
| No Amine, Stored at 50 C. | 256 | NM | 253 | 254 | NM |
| 4% MEA, Stored at 50 C. | 128 | NM | 62.6 | ND | NM |
| 4% Amine#1, Stored at 50 C. | 256 | NM | 261 | 249 | NM |
| 4% Amine#2, Stored at 50 C. | 256 | NM | 271 | 237 | NM |
| Sample ID - MIT Data | | | | | |
| 4% MEA, Stored at RT | 38.3 | 11.4 | ND | ND | NM |
| 4% MEA, Stored at 50 C. | 38.3 | NM | ND | ND | NM |
| 4% Amine#1, Stored at 50 C. | 38.2 | NM | ND | ND | NM |
| 4% Amine#2, Stored at 50 C. | 38.3 | NM | ND | ND | NM |
| Sample ID - OIT Data | | | | | |
| No Amine, Stored at RT | 274 | 205 | 206 | 206 | 206 |
| 4% MEA, Stored at RT | 274 | 67.5 | 66.4 | 57.0 | 62.8 |
| 4% Amine#2, Stored at RT | 274 | 242 | 243 | 241 | 245 |
| No Amine, Stored at 50 C. | 274 | NM | 202 | 195 | 176 |
| 4% MEA, Stored at 50 C. | 274 | NM | ND | ND | ND |
| 4% Amine#2, Stored at 50 C. | 274 | NM | 239 | 234 | 234 |
| Sample ID - DCOIT Data | | | | | |
| No Amine, Stored at RT | 602 | 612 | 612 | 608 | 609 |
| 4% MEA, Stored at RT | 601 | 214 | 42.1 | ND | ND |
| 4% Amine#1, Stored at RT | 605 | 597 | 580 | 549 | 532 |
| 4% Amine#2, Stored at RT | 605 | 624 | 611 | 577 | 552 |
| No Amine, Stored at 50 C. | 602 | NM | 609 | 602 | 598 |
| 4% MEA, Stored at 50 C. | 601 | NM | ND | ND | ND |
| 4% Amine#1, Stored at 50 C. | 605 | NM | 517 | 239 | 53 |
| 4% Amine#2, Stored at 50 C. | 605 | NM | 517 | 147 | ND |

1. An aqueous composition comprising: (a) 4,5-dichloro-2-octyl-4-isothiazolin-3-one; (b) a tertiary amine comprising three C₂-C₆ hydroxyalkyl groups, wherein at least one of said hydroxyalkyl groups has a secondary hydroxyl group; (c) an oil selected from the group consisting of mineral oil, neutral oil, castor oil, and combinations thereof; (d) a paraffin wax; and (e) a nonionic surfactant having from 20 to 50 polymerized ethylene oxide units.

2. The aqueous composition of claim 1 comprising from 200 to 1000 ppm 4,5-dichloro-2-octyl-4-isothiazolin-3-one; from 1 to 8 wt % of said tertiary amine; from 0.3 to 1.5 wt % of said oil; from 0.3 to 1.5 wt % of a paraffin wax; from 0.1 to 0.8 wt % of said nonionic surfactant and from 88 to 98 wt % water.

3. The aqueous composition of claim 2 in which said tertiary amine comprises three C₂-C₄ hydroxyalkyl groups.

4. The aqueous composition of claim 3 in which said nonionic surfactant is a castor oil ethoxylate.

5. The aqueous composition of claim 4 further comprising from 50 to 500 ppm 2-octyl-4-isothiazolin-3-one and from 25 to 400 ppm of a mixture of 2-methyl-4-isothiazolin-3-one and 5-chloro-2-methyl-4-isothiazolin-3-one.

6. The aqueous composition of claim 5 in which said tertiary amine has at least one hydroxybutyl group.

7. The aqueous composition of claim 6 in which said nonionic surfactant is a castor oil ethoxylate.

8. The aqueous composition of claim 7 in which said tertiary amine is N,N-bis(2-hydroxybutyl)-2-aminoethanol, 1-[bis(2-hydroxyethyl)amino]-2-butanol or a combination thereof.
